(19) United States
(12) Patent Application Publication
(10) Pub. No.: US 2008/0167968 A1
(43) Pub. Date: Jul. 10, 2008

(54) Creating and Purchasing Ringtones

(76) Inventors: Eddy Cue, Mountain View, CA (US); Heller David, Los Altos, CA (US); Steve Jobs, Palo Alto, CA (US); Jeffrey L. Robbin, Los Altos, CA (US); Wasko Timothy, High River (CA)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/767,418

(22) Filed: Jun. 22, 2007

Related U.S. Application Data
(63) Continuation-in-part of application No. 11/650,858, filed on Jan. 7, 2007.

(51) Int. Cl. G06Q 30/00

(52) U.S. Cl. 705/26

(57) ABSTRACT

Techniques for creating and purchasing ringtones for use in electronic devices, such as mobile phones (e.g., cellular phones) or other telephone-enabled devices (e.g., Personal Digital Assistants (PDAs), multi-function devices) are disclosed. These techniques can use a media management application and/or an online media store to browse, create, edit, purchase, and/or download ringtones for use in mobile phones or other telephone-enabled devices. Further, these techniques can be used to manage ringtones on one or more devices, including personal computers, mobile phones, and telephone-enabled devices.

### CROSS REFERENCE TO RELATED APPLICATION

This application is a Continuation-In-Part of U.S. patent application Ser. No. 11/650,858, filed Jan. 7, 2007, and entitled “Method for Purchasing and Editing Ringtones,” which is hereby incorporated herein by reference.

### BACKGROUND OF THE INVENTION

### Description of the Related Art

In recent years there has been a proliferation of “MP3 enabled” (e.g., capable of playing audio files) cellular phones (‘cell phones’). Typically, these cell phones are capable of playing audio files as a substitute for a traditional telephone ringer (i.e., the sound a telephone makes to alert a user that he is receiving a telephone call). These call notification sounds are typically referred to as ‘ringtones’. Some cell phone ringtones come bundled with a cell phone, but these ringtones are typically low quality. Currently, it is common practice to purchase upgraded ringtones to personalize a cell phone according to a user's tastes.

Current methods of purchasing and distributing ringtones leave much to be desired. Most often, the purchase of ringtones has been performed using cellular phone web browsers and the distribution of purchased ringtones has been limited to file transfers across cellular networks. Thus there is a demand for more options for purchase and download of ringtones.

Further, while many modern cell phones can play audio files, users have been limited when picking which segment of an audio file to play as a ringtone. Most often, a purchased ringtone will pertain to a pre-selected segment of a particular audio file, without any input from the purchaser. Moreover, on phones that allow a user to play any audio file as a ringtone, selecting an audio file as a ringtone often causes the telephone to play the first part of that audio file. From an aesthetic point of view, conventional ringtones may not contain the most desirable portion of the audio file. Thus, there is a need for greater flexibility in choosing which segment of an audio file will be played as a ringtone on a portable telephone.

Even further, while unprotected audio files may be edited using commonly available sound editing software, allowing users to create their own ringtones from audio files, audio files which have been encoded with a Digital Rights Management (DRM) scheme are typically uneditable and therefore unsuitable for such use. Thus, there is a need for ways to obtain ringtones associated with DRM-encoded audio files.

In recent years music delivery or distribution over the Internet has become popular. Due to the advances in efficient file formats, such as MP3 and MPEG4, the size of media files has become small enough to make their download via the Internet practical. Also, technological advances have led to higher-speed Internet connections and lower cost of memory. The combination of these advances make downloading media files, such as for music and videos, manageable and not too time consuming.

One popular approach to online music distribution is Apple's iTunes® online music store. Consumers may use the iTunes® online music store to purchase music either as individual music tracks or in albums of songs. Other music stores have also been employed to purchase music online. However, users who purchase music at an online music store do not typically gain a license to create ringtones with that music. A user who wants a ringtone typically must purchase the ringtone separately from a different vendor, since online music stores do not conventionally sell ringtones. Thus, in addition to the above concerns, there is need to make ringtones available in online music stores.

Accordingly, conventional approaches to the purchase of telephone ringtones are limited, which is a disservice to all parties involved. Thus, there is a need for improved approaches to the purchase and distribution of ringtones.

### SUMMARY OF THE INVENTION

The invention pertains to techniques for creating and purchasing ringtones for use in electronic devices, such as mobile phones (e.g., cellular phones) or other telephone-enabled devices (e.g., Personal Digital Assistants (PDAs), multi-function devices). These techniques can use a media management application and/or an online media store to browse, create, edit, purchase, and/or download ringtones for use in mobile phones or other telephone-enabled devices. Further, these techniques can be used to manage ringtones on one or more devices, including personal computers, mobile phones, and telephone-enabled devices. The invention can be implemented in numerous ways, including as a method, system, device, apparatus, graphical user interface, or computer readable medium. Several embodiments of the invention are discussed below.

As a method for creating a ringtone at a client machine, one embodiment of the invention includes at least: displaying a list of media items provided within a local media library at the client machine; identifying at least one of the media items; sending a ringtone availability request to a remote server for an indication whether a ringtone of the identified media item is permitted; receiving a ringtone availability response from the remote server; determining whether the ringtone of the identified media item is permitted based on the ringtone availability response from the remote server; and creating the ringtone on the client machine if it is determined that the ringtone of the identified media item is permitted.

As a method for managing ringtone creation, one embodiment of the invention includes at least: storing ringtone authorization data for each of a plurality of digital media assets; receiving a ringtone availability request including media asset identification information; retrieving the ringtone authorization data for a particular digital media asset identified by the media asset information; and responding to the ringtone availability request based on the retrieved ringtone authorization data.

As a computer readable medium including at least tangible program code executable by a machine, one embodiment of the invention includes at least: program code for identifying a media item; program code for sending a ringtone availability request to another machine for an indication whether a ringtone of the identified media item is permitted; program code for receiving a ringtone availability response from the another machine; program code for determining whether the ringtone of the identified media item is permitted based on the ringtone availability response from the another machine; and program code for creating the ringtone if the program code for determining determines that the ringtone of the identified media item is permitted.

As a computer readable medium including at least tangible program code executable by a machine, one embodiment of the invention includes at least: program code for storing ringtone authorization data for each of a plurality of digital media assets; program code for receiving a ringtone availability request including media asset identification information; program code for retrieving the ringtone authorization data for a particular digital media asset identified by the media asset information; and program code for responding to the ringtone availability request based on the retrieved ringtone authorization data.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a ringtone purchase system according to one embodiment of the invention.

FIG. 2 is a flow diagram of a ringtone creation process according to one embodiment of the invention.

FIG. 3 is a flow diagram of a ringtone purchase process according to one embodiment of the invention.

FIG. 4 is a flow diagram of a ringtone editing process according to one embodiment of the invention.

FIG. 5 is a block diagram of an exemplary media asset bundle according to one embodiment of the invention.

FIG. 6 is an illustration of a graphical waveform representation of an audio file according to one embodiment of the invention.

FIGS. 7A and 7B are flow diagrams of a client ringtone process according to one embodiment of the invention.

FIGS. 8A and 8B are flow diagrams of a server ringtone process according to one embodiment of the invention.

FIGS. 9A and 9B are screenshots of exemplary media management windows showing an interface for selecting, creating, and purchasing ringtones according to one embodiment of the invention.

FIG. 10 is a screen shot of an exemplary media management window showing an interface for selecting and creating ringtones according to another embodiment of the invention.

FIG. 11 shows an exemplary computer system suitable for use with the invention.

FIG. 12 is a block diagram of a mobile multi-function device according to one embodiment of the invention.

### DETAILED DESCRIPTION OF THE INVENTION

The invention pertains to techniques for obtaining ringtones for electronic devices, such as mobile telephones. The techniques for purchasing ringtones can be associated with media assets such as music files (e.g., MP3 or AAC files) or video files (e.g., television shows or movies).

The invention pertains to techniques for creating and purchasing ringtones for use in electronic devices, such as mobile phones (e.g., cellular phones) or other telephone-enabled devices (e.g., Personal Digital Assistants (PDAs), multi-function devices). These techniques can use a media management application and/or an online media store to browse, create, edit, purchase, and/or download ringtones for use in mobile phones or other telephone-enabled devices. Further, these techniques can be used to manage ringtones on one or more devices, including personal computers, mobile phones, and telephone-enabled devices. While the term ‘ringtone’ generally applies to audio cues indicating to a cell phone user that a call is being received at that user's cell phone, it can also apply to the sound a caller hears while a cell phone is ringing (e.g., ‘caller tones’). Further still, there is no reason why the term ‘ringtone’ should be limited for use in cell phones. Thus, a ringtone could be purchased for use as an alert sound for a variety of different devices, from personal computer alarm sounds and PDA alarm sounds to conventional telephones. Also, the invention is intended to cover video ringtones (e.g., video segments for use on video enabled devices) as well as audio ringtones.

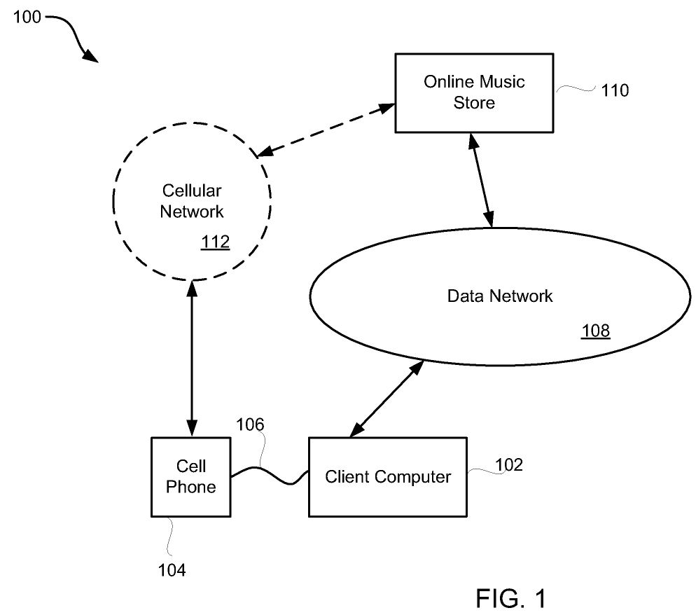

FIG. 1 is a block diagram of a ringtone purchase system 100 according to one embodiment of the invention. The ringtone purchase system 100 includes a client computer 102. The client computer 102 is, for example, a computing device, such as a personal computer. The client computer 102 can also be referred to as a host device. A cell phone 104 can be connected (e.g., temporarily connected) to the client computer 102. In one implementation, the cell phone 104 (or other telephone-enabled device) can be connected to the client computer 102 over a cable 106. As an example, the cable 106 can pertain to a peripheral bus such as a USB or Firewire® (IEEE-1394) connection. In another implementation, the cell phone 104 can connect to the client computer 102 over a wireless connection (e.g. infrared, Bluetooth®, WiFi, or WiMax). Although FIG. 1 illustrates one client computer 102 and one cell phone 104, it should be noted that the ringtone purchase system 100 can have multiple client computers 102 and multiple cell phones 104. In addition, one or more cell phones 104 can connect to one or more client computers 102.

The ringtone purchase system 100 also illustrates a data network 108. The data network 108 is, for example, a local area network (LAN), a wide area network (WAN), or a global network, such as the Internet. In one implementation of the invention, the data network 108 includes both wired and wireless portions. The client computer 102 can couple to the data network 108. In addition, the ringtone purchase system 100 includes an online music store 110. One example of an online music store is the iTunes® online music store. A user can interact with the client computer 102 to access the online music store 110 across the data network 108 to purchase media assets, including ringtones from the online media store 110. Therefore, the purchased media assets can be transferred to the cell phone 104 using the cable 106 (or wireless connection).

The ringtone purchase system 100 also illustrates a cellular network 112. The cellular network 112 is, for example, a cellular telephone network (or a combination of many cellular telephone networks). In addition to connection to the client computer 102, the cell phone 104 can connect to the cellular network 112. The cellular network 112 is capable of transferring data as well as voice (as is typical of most modern cellular networks). According to one implementation of the invention, a user may use a cell phone 104 to interact with the online music store 110 across the cellular network 112. According to another implementation of the invention, a user can use a client computer 102 to interact with an online music store 110 across a data network 108. In any case, a user can interact with the online music store 110 in order to make a purchase of a media asset (e.g., ringtone). The purchase can then be delivered to the cell phone 104 across the cellular network 112 or via the data network 108 and the client computer 102.

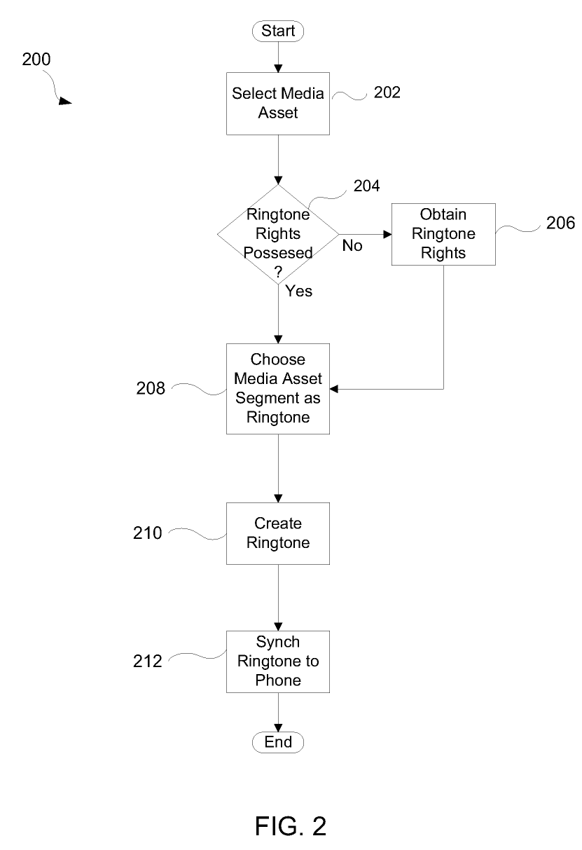

FIG. 2 is a flow diagram of a ringtone creation process 200 according to one embodiment of the invention. The ringtone creation process 200 is performed, for example, using a media management application. One example of a music management program is iTunes®, produced by Apple Inc. of Cupertino, Calif. Further, the ringtone creation process 200 can be used with the ringtone purchase system 100, described above in reference to FIG. 1.

The ringtone creation process 200 begins by selecting 202 a media asset, for example, by interacting with a media management application running on a personal computer. The selected media asset may reside locally or on a remote server, such as an online music store accessible via a computer network. One example of an online music store is the iTunes® online music store (more generally, “online media store”). Next, a decision 204 determines if rights (i.e., license or permission) to create a ringtone have been obtained. Various scenarios can occur with regard to the rights to create a ringtone. For example, the rights may have been purchased previously and not exercised or exercised previously but not limited to a single exercise of the rights (i.e., the license allows for the creation of more than one ringtone). Alternately, the rights may need to be purchased or otherwise acquired before continuing. In some scenarios, such as in the case of media assets in the public domain, the rights may be granted automatically without the purchase of additional rights. Next, if the ringtone rights have not already been obtained, the right to create a ringtone is obtained 206. For example, a user may interact with a media management application to purchase the rights or interact with a database to determine that no rights are necessary.

If decision 204 determines that the rights to create a ringtone are possessed, or upon obtaining 206 the rights to create a ringtone, a segment of the selected media asset is chosen 208 for use as a ringtone. The segment may be, for example, any thirty (30) second segment of the media asset. Of course, other length segments can be used. In some embodiments, the user may only select a segment within a pre-selected portion of the selected media asset. Marketing, media piracy concerns, and aesthetics, as well as other considerations may be taken into account when allowing a user to select 208 the segment to be used in creating the ringtone. In one embodiment, the selection of non-contiguous segments may be allowed. One other option (not shown) would be to allow a user to “remix” the ringtone (i.e., creatively modify the ringtone like dance club DJs often do) by altering the arrangement, sequence, or other parts of the selected media asset before selecting the segment to be used as a ringtone. In some embodiments of the invention, a media asset segment for the ringtone is pre-selected. The pre-selected (or ‘default’) media asset segment can be determined, for example, by the artist who recorded the media asset, the record label, marketing personnel, or randomly.

Next, the ringtone is created 210 from the selected segment. The creation may simply involve copying the selected media asset segment out of the selected media asset and creating a new file that contains the media asset segment, or can include one or more intermediate transformations, such as converting the selected media asset segment (e.g., converting an MP3 to an AAC file), making volume or pitch adjustments, or performing file compression (e.g., making the file smaller.) Additionally, the ringtone may be protected (e.g., encrypted), for example, using a DRM scheme. One example of a DRM scheme is Apple's Fairplay® DRM technology. In one embodiment, the protection (e.g., encryption) can serve to restrict usage of the ringtone to the client computer that performed the ringtone creation process 200 to create the ringtone and/or to the cell phone 104 that connects to such client computer.

Note that DRM protection can be added regardless of whether the source media asset contained DRM protection. For example, say a user chooses 208 a media asset that is an unprotected MP3 file in that user's collection. According to some embodiments of the invention, the ringtone created 210 from that unprotected file can be encrypted using a DRM scheme. In this way, artists or music labels gain separate control over the right to create ringtones from previously purchased music.

Once the ringtone has been created 210, the ringtone can be ‘synched’ 212 (i.e., transferred via a synchronization process between two devices) to a cell phone, for example using a connection between a personal computer (PC) and a cellular phone. Any number of commonly used synchronization types may be used including, but not limited to, using a cable interface between a PC and a phone (e.g., USB or Firewire® (IEEE-1394)) or by using a wireless connection between a PC and phone (e.g. infrared, Bluetooth®, WiFi, WiMax, etc.) Alternately, a cellular network may be used to download the ringtone directly to the cell phone via a data connection (not shown). Further, the synching operation 212 can be used for synching 212 multiple ringtones as well as for a single ringtone.

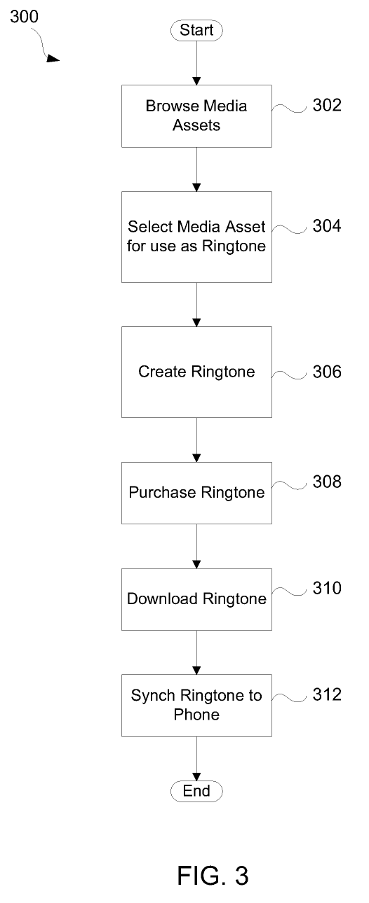

FIG. 3 is a flow diagram of a ringtone purchase process 300 according to one embodiment of the invention. The ringtone purchase process 300 is performed, for example, using a media management application to interact with an online media store. One example of a music management program is iTunes®, produced by Apple Inc. of Cupertino, Calif. One example of an online music store is the iTunes® online music store.

The ringtone purchase process 300 begins by browsing 302 media assets in an online media store. Once a desired media asset has been found, that media asset is selected 304 by the user. Next, the ringtone is created 306 using the selected media asset. The creating 306 can, for example, include choosing 208 of a media asset segment as described above in reference to FIG. 2. Next, the ringtone is purchased 308 from the online media store. For example, by interacting with the online media store to specify account information or to enter payment information such as credit card information. In some embodiments of the invention, the purchase 308 of the ringtone may be included in the purchase of a media asset bundle. For example, a media asset bundle can include one or more music files, a video file, and a ringtone. After the ringtone is purchased, the purchased ringtone can be downloaded 310 to the user's computer. Finally, the ringtone is transferred to a cell phone via a synching operation 312. The synching operation can be similar to the synching operation 212 as described above in reference to FIG. 2.

In some embodiments of the invention, the purchased ringtone can be downloaded directly to the device that will use the ringtone, for instance, to a cell phone, eliminating the need for the synching operation 312. In these embodiments, the purchase of the ringtone can also occur at the cell phone, with the charge going directly to the cell phone provider who, in turn, may bill the user directly. In this manner, a cell phone provider account can be used in lieu of a user account on an online music store.

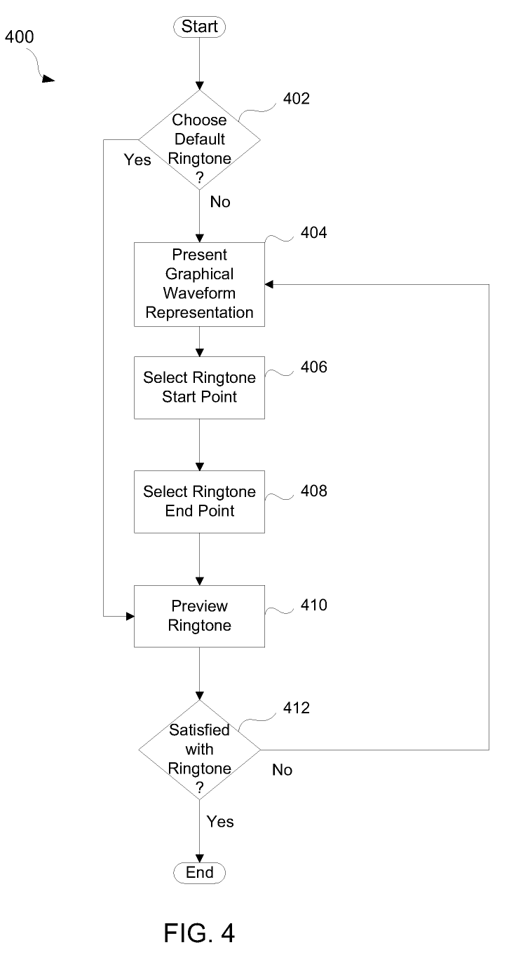

FIG. 4 is a flow diagram of a ringtone editing process 400 according to one embodiment of the invention. The ringtone editing process 400 can occur, for example, along with the choosing 208 of a media asset segment or during the creation 306 of a ringtone, described in reference to FIGS. 2 and 3, respectively.

The ringtone editing process 400 begins with decision 402, which gives the user the option to choose a default ringtone, thus allowing the user to avoid having to edit the ringtone himself. The default media asset segment is pre-selected for the user and can be determined, for example, by the artist who recorded the media asset, the record label, marketing personnel, or randomly. Choosing the default ringtone may be desirable for users who feel they lack the time or talent to create a better ringtone on their own. If the user elects this option, then decision 402 directs the ringtone editing process 400 to block 410 and subsequent blocks. If decision 402 determines that the user has not elected to take the default ringtone, then a graphical waveform representation of some or all of the media asset can be presented 404 to the user. The graphical waveform presentation typically shows the user a visual representation of the sounds contained in an audio file, much as they would appear when measured by a conventional signal generator connected to a microphone. Next, the user selects a media asset segment by selecting 406 the start of the ringtone and by selecting 408 the end of the ringtone. Once selections 406 and 408 have been made, the user can preview 410 the selection they have made for the ringtone (i.e., the proposed ringtone). Next, a decision 412 determines if the user is satisfied with the selected ringtone segment. If the decision 412 determines that the user is not satisfied with the selected ringtone segment as illustrated by the preview 410, the ringtone editing process 400 returns to block 404 and subsequent blocks. If, on the other hand, if the decision 412 determines that the user is satisfied with the ringtone as previewed 410, the ringtone editing process 400 ends.

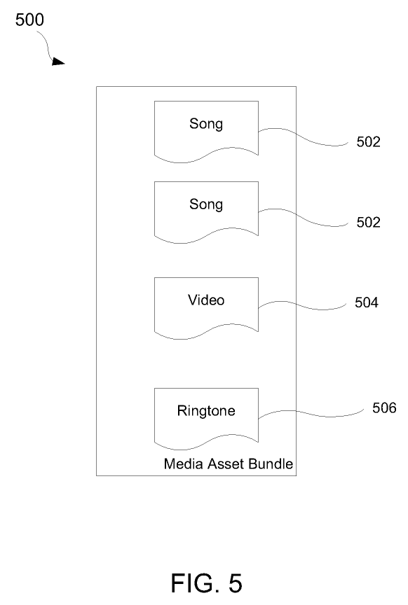

FIG. 5 is a block diagram of an exemplary media asset bundle 500 according to one embodiment of the invention. A media asset bundle is a collection of media assets grouped together for artistic or marketing reasons. One example of a media asset bundle is a collection of songs by one or more artists, such as a playlist or album. Another example is a collection of television episodes. Still another example is a collection of photographs. Media assets may be bundled as an incentive to a customer to buy the entire bundle at a discount, rather than buy each media asset separately. A media asset bundle can be any combination of media assets. Exemplary media asset bundle 500 contains song files 502, a music video file 504, and a ringtone 506.

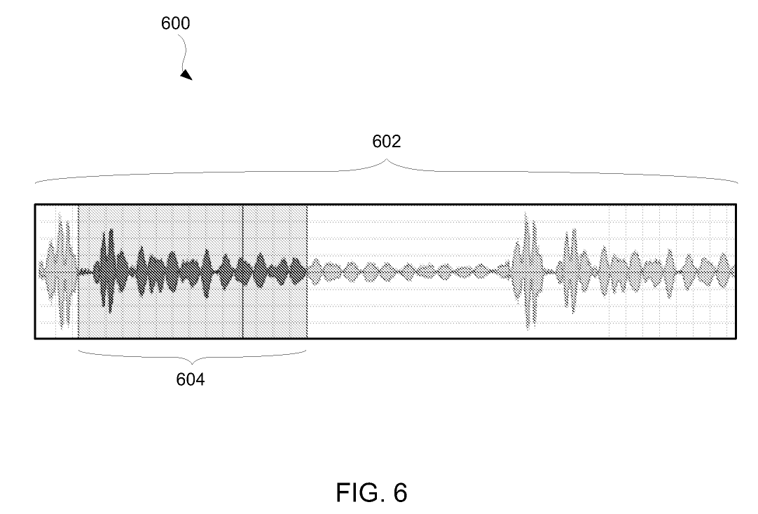

FIG. 6 is an illustration of an exemplary graphical waveform representation 600 of an audio file according to one embodiment of the invention. The exemplary graphical waveform representation 400 can be used as the waveform as presented 404 above in reference to FIG. 4.

The graphical waveform representation 600 has two segments. The first is a song segment 602. As described above in reference to FIG. 2, song segment 602 can be a complete song or a partial song. Also shown is a ringtone segment 604. The ringtone segment 604 can, for example, be a default ringtone segment as described above in reference to FIG. 4, above. Alternately, the ringtone segment 604 can be selected as described in reference to FIGS. 2 and 4, above. In one embodiment, the start point and end point for the ringtone segment 604 are alterable by the user to select different portions of the song segment 602 to serve as the ringtone segment 604.

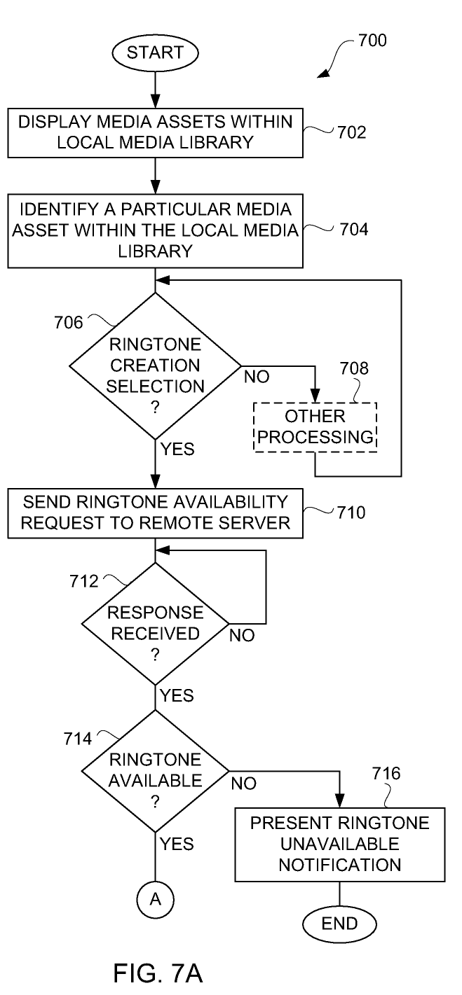

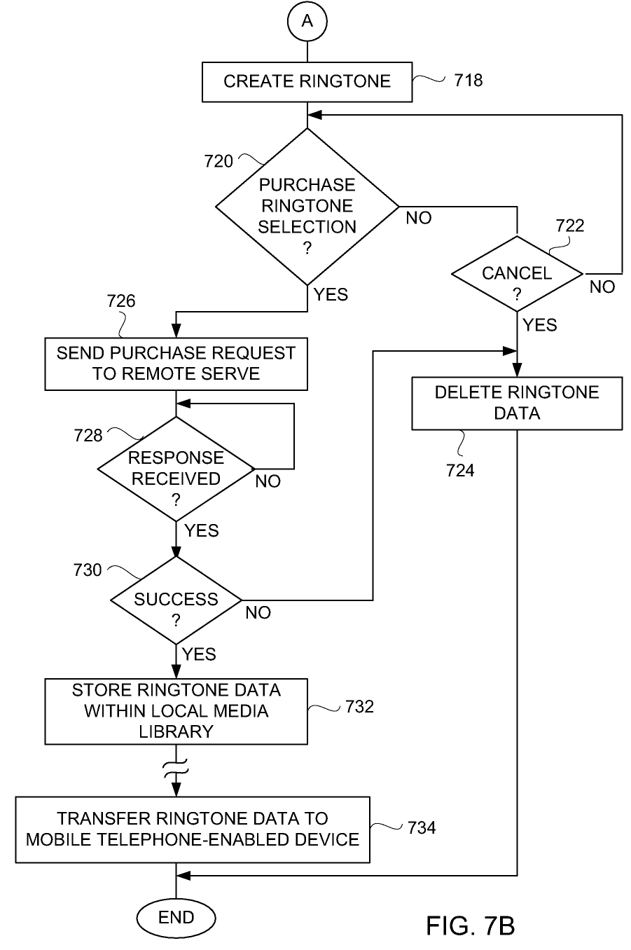

FIGS. 7A and 7B are flow diagrams of a client ringtone process 700 according to one embodiment of the invention. The client ringtone process 700 is performed on a client device. For example, the client device can pertain to the client computer 102 illustrated in FIG. 1. In one implementation, the client ringtone process 700 is part of a media management application that executes on the client device to interact via a network with a remote server that has access to media data.

The client ringtone process 700 can initially display 702 media assets that reside within a local media library. In one implementation, the client device is a personal computer system and the local media library is stored by the computer system. A particular media asset within the local media library can next be identified 704. For example, a user can interact with the media assets being displayed, such as in a list, to highlight a particular media asset within the list, thereby identifying 704 the particular media asset.

Next, a decision 706 determines whether a ringtone creation selection has been made. A ringtone creation selection can be made by the user of the client device. For example, a menu command or user interface control (e.g., button) can be provided on a graphical user interface (which can also display the media assets) so that the user can request ringtone creations. When the decision 706 determines that a ringtone creation selection has not been received, optionally other processing 708 can be performed. The other processing 708 can pertain to various other functions or operations, such as the functions or operations of the media management application. In any case, following the optional block 708, the client ringtone process 700 returns to repeat the decision 706 to again evaluate whether a ringtone creation selection has been received.

Once the decision 706 determines that a ringtone creation selection has been received, a ringtone availability request can be sent 710 to the remote server. The remote server includes, or is associated with, a media repository for a plurality of media assets. Typically, the client device stores within the local media library one or more of the media assets that are available from the media repository. After the ringtone availability request has been sent 710 to the remote server, a decision 712 determines whether a response has been received. When the decision 712 determines that a response has not yet been received, the client ringtone process 700 can await such a response. Once the decision 712 determines that a response has been received, a decision 714 can determine whether a ringtone is available for the particular media asset. The response from the remote server can indicate whether or not the ringtone is available to the user. When the decision 714 determines that the ringtone is not available to the user, a ringtone unavailable notification can be presented 716 at the client device. The ringtone unavailable notification can serve to the notify the user that the particular media asset for which they have requested a ringtone does not permit ringtone creation. Hence, following the block 716, the client ringtone process 700 can end without having created a ringtone.

On the other hand, when the decision 714 determines that a ringtone is available for the particular media asset, a ringtone can be created 718. In one embodiment, a graphical user interface can present a ringtone creation region (e.g., pane, tab or window) to assist the user of the client device in creating a ringtone from the particular media asset. The manner by which the ringtone is created 718 can vary with implementation. However, in one implementation, the ringtone creation 718 can operate in a manner as discussed above with respect to the ringtone editing process 400 illustrated in FIG. 4. Additionally, in one embodiment, if the response to the ringtone availability request provides ringtone restrictions, the ringtone restrictions can be imposed by the client device such as duration creation 718 of the ringtone.

Nevertheless, after the ringtone is created 718, a decision 720 can determine whether a purchase ringtone selection has been made. Here, the user of the client device, once having created a ringtone, can request to purchase the ringtone. In this regard, the user can interact with a graphical user interface control to signal the client ringtone process 700 that the ringtone that has been created 718 is to be purchased. Accordingly, when the decision 720 determines that a purchase ringtone selection has not yet been made, a decision 722 determines whether the client ringtone process 700 should be canceled. The user can cancel the client ringtone process 700, when, for example, the user chooses not to purchase (i.e., buy) the ringtone that has been created. When the decision 722 determines that the client ringtone process 700 should be canceled, the ringtone data associated with the ringtone that was created 718 can be deleted 724.

On the other hand, when the client ringtone process 700 is not canceled, the client ringtone process 700 can return to repeat the decision 720 and subsequent blocks to effectuate purchase of the ringtone. In particular, a purchase request is sent 726 to the remote server. The purchase request informs the remote server that the user of the client device desires to purchase a ringtone they have created for the particular media asset. A decision 728 can then determine whether a response has been received from the remote server with respect to the purchase request. When the decision 728 determines that a response to the purchase request has not been received, the client ringtone process 700 can await such a response. On the other hand, when the decision 728 determines that a response to the purchase request has been received, a decision 730 determines whether the purchase request has been successfully processed. When the decision 730 determines that the purchase request has been successfully processed, the ringtone data for the created ringtone can be stored 732 within the local media library. By storing the ringtone data within the local media library, the media management application operating on the client device is able access the ringtone data to play the ringtone as appropriate, such as when an incoming telephone call is received by the client device.

Subsequently, the ringtone data can be transferred 734 to a mobile telephone-enabled device when a data connection is present between the client device and the mobile telephone-enabled device. The mobile telephone-enabled device can thereafter utilize the ringtone data when an incoming call is received at the mobile telephone-enabled device. The transfer 734 of the ringtone data to the mobile telephone-enabled device can, for example, be performed during a synchronization operation between the client device and the mobile telephone-enable device. Following the blocks 724 and 734, the client ringtone process 700 can end.

In one embodiment, when the ringtone data is transferred 734 during a synchronization operation, the transfer can be performed in accordance with user-specified preferences. Additional information concerning user-specified preferences for synchronization are described in U.S. application Ser. No. 11/679,082, filed Feb. 26, 2007, and entitled “DATA SYNCHRONIZATION WITH HOST DEVICE IN ACCORDANCE WITH SYNCHRONIZATION PREFERENCES,” which is hereby incorporated herein by reference.

The decision 714 of the client ringtone process 700 can limit ringtone creation 718 at the client device. The remote server can provide authorization information with the response to the ringtone availability request. Hence, the remote server can centrally store information on which of the media assets it maintains are eligible for ringtone creation. Here, the remote server can operate to instruct the client device to limit ringtone creation.

Additionally, it should be noted that the client ringtone process 700 can restrict ringtone creation to certain categories of ringtones. For example, ringtone creation can be limited so as to available only from media items that have been purchase from an authorized online media store. As another example, ringtone creation can be limited so as to be available from media assets that have been purchased or acquired from authorized sources. For instance, media assets that are imported or uploaded from an original compact disc (CD) into a local media library can be authorized for ringtone creation; whereas, media assets obtain from peer-to-peer file sharing can be unauthorized for ringtone creation. To the extend that ringtone creation limitations are imposed, these limitations can be imposed by the client device and/or the remote server.

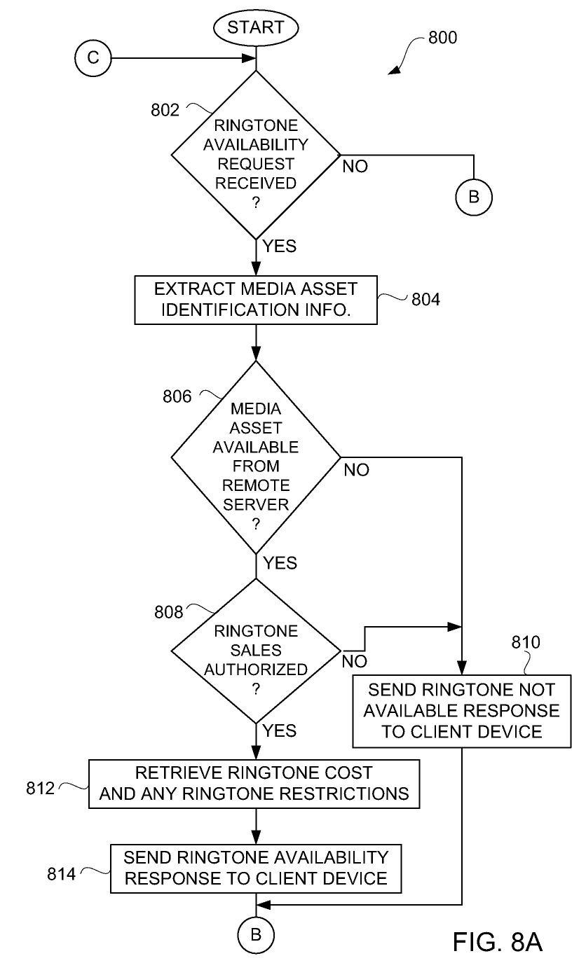

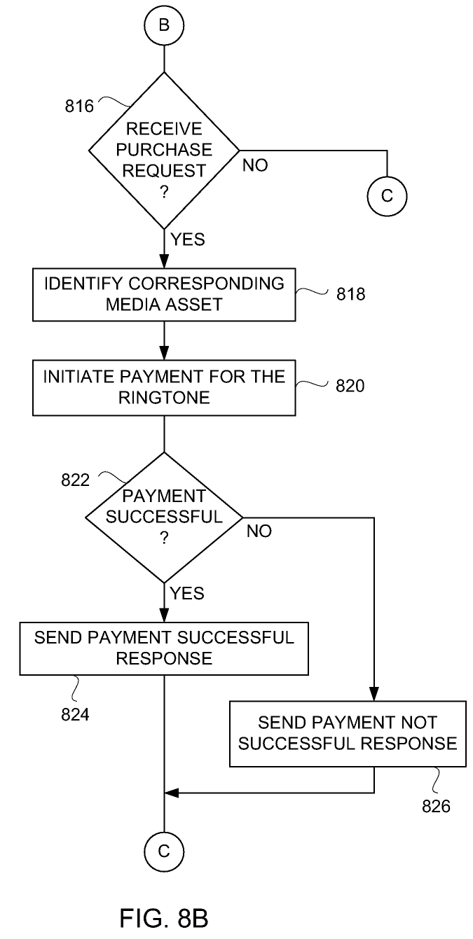

FIGS. 8A and 8B are flow diagrams of a server ringtone process 800 according to one embodiment of the invention. In one embodiment, the server ringtone process 800 is counterpart processing for the client ringtone process 700 illustrated in FIGS. 7A and 7B. The server ringtone process 800 is, for example, processing performed a server device. The server device is, for example, remotely located (i.e., remote server) as compared to the client device which is local. In one implementation, the remote server can pertain to the online music store 110 illustrated in FIG. 1.

The server ringtone process 800 can begin with a decision 802 that determines whether a ringtone availability request has been received. When the decision 802 determines that a ringtone availability request has been received, media asset identification information can be extracted 804 from the ringtone availability request. As an example, the media asset identification information can pertain to (i) an identification code that uniquely identifies the media asset and/or (ii) metadata for the media asset that can be used to locate the media asset on the remote server.

A decision 806 can then determine whether the media asset is available from the remote server. When the decision 806 determines that the media asset for which a ringtone is being requested is, in fact, available from the remote server, a decision 808 can determine whether ringtone sales are authorized for the media asset. When the decision 808 determines that ringtone sales are not authorized for the media asset, a ringtone not available response can be sent 810 to the client device. In addition, in one embodiment, when the decision 806 determines that the media asset is not available from the remote server, the ringtone is also deemed not available. Accordingly, when the decision 806 determines that the media asset is not available from the remote server, a ringtone not available response can also be sent 810 to the client device.

On the other hand, when the decision 808 determines that ringtone sales are authorized for the media asset, a ringtone cost and any ringtone restrictions associated with the media asset can be retrieved 812. In one implementation, the ringtone cost can be the same for any media asset. In another media asset, the ringtone cost can be dependent on the media asset. Still further, optionally, the ringtone cost could be dependent on one or more of: ringtone duration, ringtone quality, ringtone mix or ringtone special effects. The ringtone mix (or remix) or special effects are audio alterations or enhancements imposed or requested on creation of the ringtone, which can yield a custom ringtone. A ringtone restriction is a restriction imposed on the ability to produce a ringtone from a media asset. For example, an artist, label or seller can through a ringtone restriction achieve various restrictions on ringtone creations, such as one or more of: limit duration of ringtone, limit available segments for selected for the ringtone, limit any mixing/remixing, customizing or special effects.

Next, a ringtone availability response can be sent 814 to the client device. The ringtone availability response can include an indication of whether ringtones are permitted to be created from the media asset. Optionally, the ringtone availability response can include one or more of the ringtone cost and any ringtone restrictions. Following the block 814, as well as following the block 810, a decision 816 can determine whether a purchase request has been received.

When the decision 816 determines that a purchase request has been received, a corresponding media asset for the ringtone can be identified 818. In one embodiment, the purchase request for a ringtone can specify the corresponding media asset. After the media asset corresponding to the ringtone to be purchased has been identified 818, payment for the ringtone can be initiated 820. The payment can be achieved through use of a preexisting customer account or by online payment. In another embodiment, the payment for the ringtone can be bypassed in cases where the ringtone is available without cost (i.e., free), such as for trial usage, promotional reasons, or other reasons. In any case, once the payment for the ringtone has been initiated 820, a decision 822 determines whether the payment has been successful. When the decision 822 determines that payment for the ringtone has been successful, a payment successful response is sent 824. Typically, the payment successful response will thereafter be presented at the client device so as to inform the user that payment for the ringtone has been successfully submitted for payment or successfully completed.

Alternatively, when the decision 822 determines that the payment has not been successful, a payment not successful response can be sent 826 to the client device. At the client device, the payment not successful response can be displayed to notify the user that payment for the ringtone did not successfully complete. Following the blocks 824 and 826, the server ringtone process 800 can return to repeat the decision 802 and subsequent blocks so that the remote server can continue to monitor for ringtone availability requests as well as purchase requests for ringtones. Likewise, following the decision 816 when a purchase request is not received, the server ringtone process 800 can return to repeat the decision 802 and subsequent blocks.

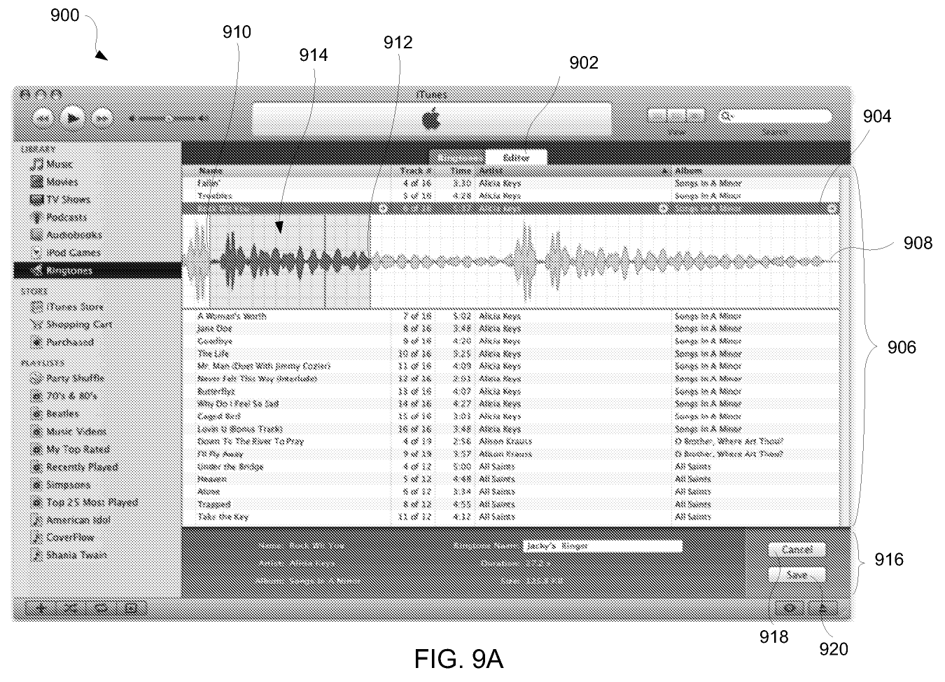

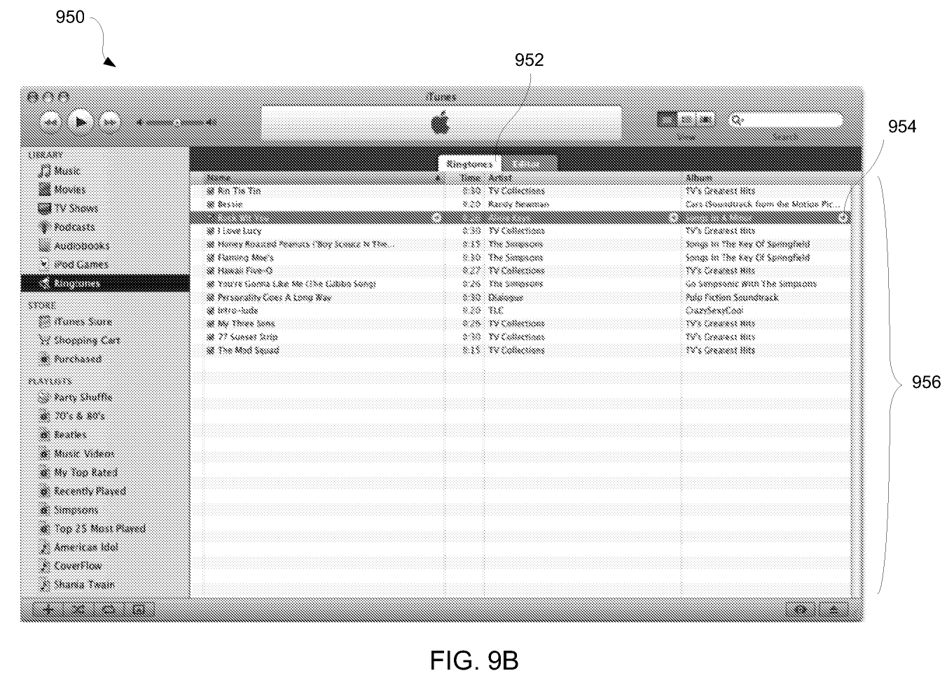

FIG. 9A is a screenshot of an exemplary media management window 900 showing an interface for selecting and creating ringtones according to one embodiment of the invention. In window 900, a Ringtone ‘Editor’ Tab 902 is selected. When the ringtone editor is active, selecting a music track 904 in the track listing 906 brings up a graphical waveform representation 908 of that music track 904. The information displayed in the track listing 906 gives information of partial or complete tracks that can be used to create ringtones. The graphical waveform representation 908 has a ringtone starting point 910 and a ringtone ending point 912 shown, which in turn define a ringtone 914. In this interface, the starting 910 and ending 912 points can be moved under user control. Below the track listing 906, is the ringtone information section 916, showing the information, including artist name, song name, album name, ringtone duration, ringtone size, and ringtone name. Finally, two interface controls, cancel button 918 and save button 920, allow the user to accept or cancel changes made to the ringtone 914.

FIG. 9B is a screenshot of an exemplary media management window 950 showing an interface for browsing ringtones according to one embodiment of the invention. In window 950, the ‘Ringtones’ tab 952 is selected. Ringtone information for those ringtones within a library (e.g., local media library) are displayed in the ringtone list 956. The ringtone information for each ringtone can include name, time (duration), artist and album. In window 950, a ringtone 954 is selected from a ringtone list 956.

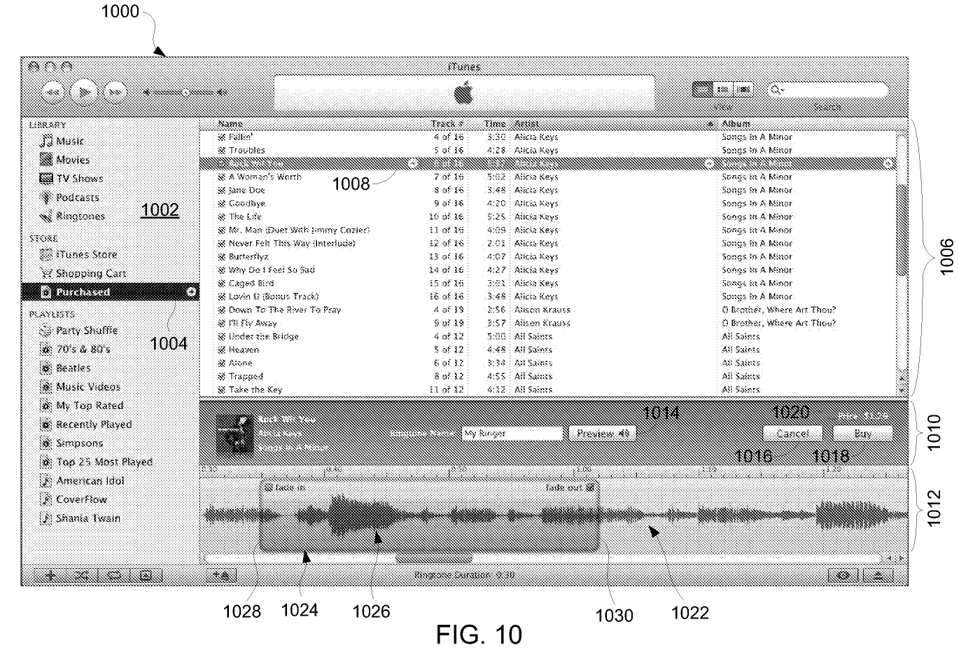

FIG. 10 is a screen shot of an exemplary media management window 1000 showing an interface for selecting and creating ringtones according to another embodiment of the invention. The window 1000 includes a media source region 1002 that permits a user to select a particular media source. As illustrated in FIG. 10, the media category “Purchased” is shown being highlighted 1004. The highlighting servers to visually distinguish the “Purchased” media category within the media source area 1002. A track listing 1006 displays a list of media items. In the example illustrated in FIG. 10, the media items in the track listing 1006 are those media items that have been purchased from an online music store. In one embodiment of the invention, any of the media items listed within the track listings 1006 can be selected for use in creating a ringtone. As illustrated in FIG. 10, a highlight bar 1008 identifies a particular media item for which a ringtone is to be created. Hence, after the highlight bar 1008 is used to identify a particular media item, a graphical user interface control (such as a menu command or displayed button) can be activated to initiate a ringtone creation process. In such case, as shown in FIG. 10, the window 1000 can further display a ringtone information section 1010 and a graphical waveform representation section 1012 for the media item. The ringtone information section 1010 presents information and user interface controls for use with respect to ringtones. The ringtone information can include artist name, song/album name, ringtone duration, ringtone size and ringtone name. In addition, one or more user interface controls can be provided within the ringtone information section 1010. For example, a preview button 1014 can allow the user to preview the ringtone being created. A cancel control 1016 can serve to cancel the ringtone creation. A buy button 1018 can enable the user of the client device to buy the ringtone at a designated price 1020.

To create the ringtone, the user of the client device can interact with a graphical waveform representation 1022 pertaining to a media item presented in the graphical waveform representation section 1012. The ringtone being created will correspond to a portion of the media item. For example, when the media item is a song, the ringtone will be a selected portion of the song. The graphical waveform representation section 1012 can include a ringtone overlay 1024. The ringtone overlay 1024 is a translucent user interface control that specifies a portion of the graphical waveform representation 1022 for the media item that is to correspond to a ringtone 1026 being formed. The ringtone overlay 1024 has a front end 1028 and a back end 1030. The front end 1028 designates a beginning of the portion of the waveform representation of the media item that is to be utilized for the ringtone 1026, whereas the back end 1030 designates an end of the portion of the waveform representation of the media item that is to be utilized for the ringtone 1026. Typically, the duration (or length) of the ringtone will be approximately 30 seconds. In one implementation, the duration is fixed (e.g., 30 seconds). In another implementation, the duration is user-determinable. The length of the ringtone overlay 1024 can represent the duration of the ringtone. In one example, if the user is permitted to alter the length of the ringtone overlay 1024, then the duration of the ringtone can be correspondingly altered.

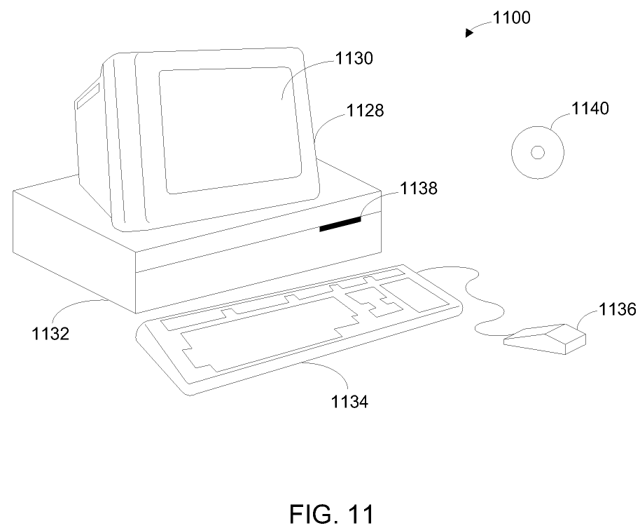

FIG. 11 shows an exemplary computer system 1100 suitable for use as a client device according to one embodiment of the invention. The computer system 1100 includes a display monitor 1128 having single or multi-screen displays 1130 (or multiple displays), cabinet 1132, keyboard 1134, and mouse 1136. Cabinet 1132 houses a drive 1138, such as a CD-ROM, or floppy drive, system memory and a hard drive (not shown) which may be utilized to store and retrieve software programs incorporating computer code that implements the present invention, data for use with the invention, and the like. Although CD-ROM 1140 is shown as an exemplary computer readable storage medium, other computer readable storage media including CD-R, CD-RW, DVD, DVD-R, DVD-RW, floppy disk, tape, flash memory, system memory, and hard drive may be utilized. Additionally, a data signal embodied in a carrier wave (e.g., in a network including the Internet) may be the computer readable storage medium. In one implementation, an operating system for the computer system 1100 is provided in the system memory, the hard drive, the CD-ROM 1140 or other computer readable storage medium and serves to incorporate the computer code that implements the invention.

A mobile multi-function device operates to support a plurality of different functions. For example, a mobile multi-function device can operate as a media playback device, such as an MP3 player, video player, game player, etc. In addition, the mobile multi-function device can support wireless voice communications through a wireless network. The wireless voice communications through the wireless network can enable a user of the mobile multi-function device to communicate with users of other mobile multi-function devices or other communication devices. Similarly, the mobile multi-function device can support wireless data exchange (e.g., SMS messages) through the wireless network.

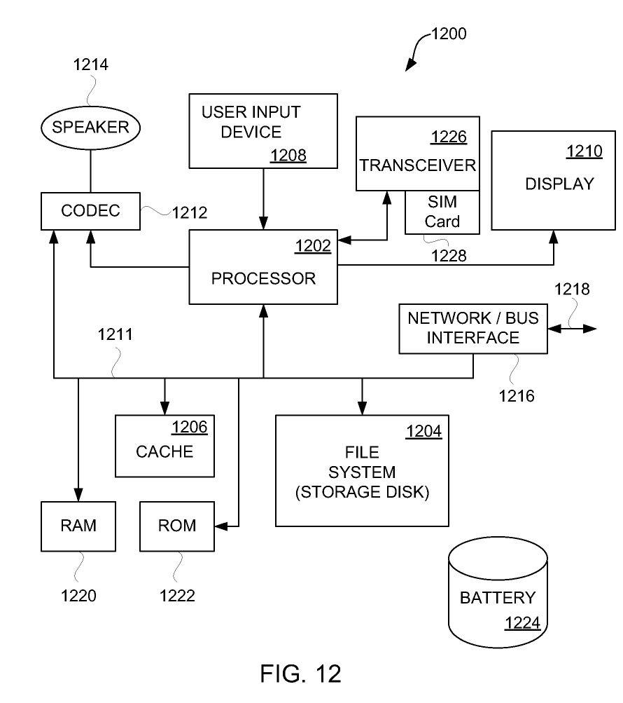

FIG. 12 is a block diagram of a mobile multi-function device 1200 according to one embodiment of the invention. The mobile multi-function device 1200 is one embodiment of a mobile phone or a telephone-enabled device. For example, the mobile multi-function device 1200 is suitable for use as the cell phone 104. The mobile multi-function device 1200 includes hardware and software components to provide at least two functions, namely, a media playback function and a wireless voice communications function. When providing media playback, the mobile multi-function device 1200 can operate as a media player capable of playing (including displaying) media items. The media items can, for example, pertain to audio items (e.g., audio files or songs), videos (e.g., movies) or images (e.g., photos). When providing wireless voice communications, the mobile multi-function device 1200 can operate a mobile telephone (e.g., cellular phone).

The mobile multi-function device 1200 includes a processor 1202 that pertains to a microprocessor or controller for controlling the overall operation of the mobile multi-function device 1200. The mobile multi-function device 1200 stores media data pertaining to media items in a file system 1204 and a cache 1206. In one embodiment, the file system 1204 is implemented by a storage disk or a plurality of disks. In another embodiment, the file system 1204 is implemented by EEPROM or Flash type memory. The file system 1204 typically provides high capacity storage capability for the mobile multi-function device 1200. However, since the access time to the file system 1204 is relatively slow, the mobile multi-function device 1200 can also include a cache 1206. The cache 1206 is, for example, Random-Access Memory (RAM) provided by semiconductor memory. The relative access time to the cache 1206 is substantially shorter than for the file system 1204. However, the cache 1206 does not have the large storage capacity of the file system 1204. Further, the file system 1204, when active, consumes more power than does the cache 1206. The power consumption is often a concern when the mobile multi-function device 1200 is a portable mobile multi-function device that is powered by a battery 1224. The mobile multi-function device 1200 also includes a RAM 1220 and a Read-Only Memory (ROM) 1222. The ROM 1222 can store programs, utilities or processes to be executed in a non-volatile manner. The ROM 1222 can be implemented by an EEPROM or Flash type memory so as to provide writable non-volatile data storage. The RAM 1220 provides volatile data storage, such as for the cache 1206.

In one embodiment, to support wireless voice communications, the mobile multi-function device 1200 includes a transceiver 1226 and a SIM card 1228. The transceiver 1226 supports wireless communication with a wireless network (such as a wireless cellular network). The SIM card 1228 includes an identifier (e.g., SIM identifier) can be used by the mobile multi-function device 1200 to gain access and utilize the wireless network. In other embodiments, a SIM card 1228 is not utilized.

The mobile multi-function device 1200 also includes a user input device 1208 that allows a user of the mobile multi-function device 1200 to interact with the mobile multi-function device 1200. For example, the user input device 1208 can take a variety of forms, such as a button, keypad, dial, etc. Still further, the mobile multi-function device 1200 includes a display 1210 (screen display) that can be controlled by the processor 1202 to display information to the user. A data bus 1211 can facilitate data transfer between at least the file system 1204, the cache 1206, the processor 1202, and the CODEC 1212.

In one embodiment, the mobile multi-function device 1200 serves to store a plurality of media items (e.g., songs) in the file system 1204. When a user desires to have the mobile multi-function device play a particular media item, a list of available media items is displayed on the display 1210. Then, using the user input device 1208, a user can select one of the available media items. The processor 1202, upon receiving a selection of a particular media item, supplies the media data (e.g., audio file) for the particular media item to a coder/decoder (CODEC) 1212. The CODEC 1212 then produces analog output signals for a speaker 1214. The speaker 1214 can be a speaker internal to the mobile multi-function device 1200 or external to the mobile multi-function device 1200. For example, headphones or earphones that connect to the mobile multi-function device 1200 would be considered an external speaker.

The mobile multi-function device 1200 also includes a bus interface 1216 that couples to a data link 1218. The data link 1218 allows the mobile multi-function device 1200 to couple to a host device (e.g., host computer or power source). The data link 1218 can also provide power to the mobile multi-function device 1200.

Although one or more of the embodiments discussed above make use of a previously purchased media asset available to a client device in order to create a ringtone, it should be understood that, in an alternative embodiment, a user lacking a needed (purchased) media asset could interact with an online media store to locate and purchase a ringtone (i.e., ringtone rights). Once the ringtone is purchased, the needed media asset from which the ringtone is to be created can be downloaded to the purchaser. The download media asset can be rendered only temporarily available to the purchaser for use in creating the ringtone from the downloaded media asset.

The various aspects, embodiments, implementations or features of the invention can be used separately or in any combination.

The invention can be implemented by software, hardware or a combination of hardware and software. The invention can also be embodied as computer readable code on a computer readable medium. The computer readable medium is any data storage device that can store data which can thereafter be read by a computing device (e.g., computer system). Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of this invention is that users may browse, create and organize ringtones. Another advantage of the invention is that user can purchase ringtones that have or can be customized. Still another advantage is that artists or labels can exert more control over the sale of their songs as cell phone ringtones. Yet still another advantage of the invention is that prohibitions or restrictions regarding creation of ringtones can be imposed and managed.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for creating a ringtone at a client machine, said method comprising:
displaying a list of media items provided within a local media library at the client machine;
identifying at least one of the media items;
sending a ringtone availability request to a remote server for an indication whether a ringtone of the identified media item is permitted;
receiving a ringtone availability response from the remote server;
determining whether the ringtone of the identified media item is permitted based on the ringtone availability response from the remote server; and
creating the ringtone on the client machine if said determining determines that the ringtone of the identified media item is permitted.

2. A method as recited in claim 1, wherein said method further comprises:
subsequently copying ringtone data pertaining to the ringtone from the client machine to a mobile electronic device having wireless communications capabilities.

3. A method as recited in claim 2, wherein said copying of the ringtone data occurs during a synchronization process between the client machine and the mobile electronic device.

4. A method as recited in claim 2, wherein said method further comprises:
thereafter presenting the ringtone at the mobile electronic device by outputting the ringtone data to an audio output device.

5. A method as recited in claim 4, wherein said presenting of the ringtone signals an incoming call to the mobile electronic device.

6. A method as recited in claim 1, wherein said method further comprises:
sending a purchase request to the remote server to request purchase of the ringtone;
receiving a ringtone purchase response from the remote server indicating that payment for the ringtone has been accepted or denied; and
storing ringtone data pertaining to the ringtone at the client machine if payment for the ringtone has been accepted.

7. A method as recited in claim 6, wherein said storing stores the ringtone data in a Digital Rights Management (DRM) protected manner.

8. A method as recited in claim 6, wherein said storing stores the ringtone data in the local media library at the client machine.

9. A method as recited in claim 1, wherein said creating the ringtone on the client machine comprises:
displaying a visual representation of the identified media item;
receiving an identification of a segment of the visual representation of the identified media item to be used as the ringtone; and
forming the ringtone from the segment of the visual representation that has been identified.

10. A method as recited in claim 9, wherein said receiving of the identification of the segment of the visual representation of the identified media item comprises:
receiving a first selected point on the visual representation of the identified media item for use as a starting point for the segment; and
receiving a second selected point on the visual representation of the identified media item for use as an ending point for the segment.

11. A method as recited in claim 9, wherein said method further comprises:
previewing the ringtone; and
purchasing the ringtone.

12. A method as recited in claim 1, wherein said creating the ringtone on the client machine comprises:
determining a duration for the ringtone.

13. A method as recited in claim 1, wherein the ringtone availability response further includes at least one ringtone restriction to be imposed, and
wherein said method further comprises:
determining whether creation of the ringtone on the client machine is restricted based on the ringtone availability response.

14. A method as recited in claim 1, wherein said method further comprises:
limiting ringtone creation from only those of the media items that have been purchased from an authorized online store.

15. A method as recited in claim 1, wherein said method further comprises:
determining whether at least one ringtone restriction is to be imposed on said creating of the ringtone based on the ringtone availability response from the remote server; and
imposing the at least one ringtone restriction during said creating of the ringtone if said determining determines that the at least one ringtone restriction is to be imposed.

16. A method as recited in claim 1, wherein said method is performed by a media management application operating on the client machine.

17. A method for managing ringtone creation, said method comprising:
storing ringtone authorization data for each of a plurality of digital media assets;
receiving a ringtone availability request including media asset identification information;
retrieving the ringtone authorization data for a particular digital media asset identified by the media asset information; and
responding to the ringtone availability request based on the retrieved ringtone authorization data.

18. A method as recited in claim 17, wherein said responding responds with a ringtone availability response.

19. A method as recited in claim 18,
wherein said method further comprises:
determining whether the ringtone authorization data for the particular digital media asset identified by the media asset information authorizes creation of a ringtone, and
wherein the ringtone availability response indicates based on said determining whether creation of the ringtone from the particular media asset is authorized.

20. A method as recited in claim 18, wherein the ringtone availability response further includes at least one ringtone restriction to be imposed.

21. A method as recited in claim 18, wherein when the ringtone availability response indicates that the ringtone is permitted to be created from the particular media asset, the ringtone availability response includes at least a cost for creation of the ringtone.

22. A method as recited in claim 18, wherein when the ringtone availability response indicates that the ringtone is permitted to be created from the particular media asset, the ringtone availability response includes at least one ringtone restriction.

23. A method as recited in claim 18,
wherein said method further comprises:
determining whether the ringtone authorization data for the particular digital media asset identified by the media asset information authorizes creation of a ringtone, and
wherein the ringtone availability response indicates based on said determining whether creation of the ringtone from the particular media asset is authorized and at least one ringtone restriction.

24. A method as recited in claim 17,
subsequently receiving a purchase request for the ringtone; and
initiating payment for the ringtone.

25. A method as recited in claim 17,
storing ringtone cost data for each of a plurality of digital media assets; and
retrieving the ringtone cost for the particular media asset based on the stored ringtone cost data.

26. A method as recited in claim 25, wherein said responding responds with a ringtone availability response, and wherein the ringtone availability response includes at least the ringtone cost for the particular media asset.

27. A method as recited in claim 17, wherein said method is performed by a server machine associated with an online media store, the online media store having the digital media assets available for purchase.

28. A computer readable medium including at least tangible program code executable by a machine, said computer readable medium comprising:
program code for identifying a media item;
program code for sending a ringtone availability request to another machine for an indication whether a ringtone of the identified media item is permitted;
program code for receiving a ringtone availability response from the another machine;
program code for determining whether the ringtone of the identified media item is permitted based on the ringtone availability response from the another machine; and
program code for creating the ringtone if said program code for determining determines that the ringtone of the identified media item is permitted.

29. A computer readable medium as recited in claim 28, wherein said computer readable medium further comprises:
program code for copying ringtone data pertaining to the ringtone from the machine to a mobile electronic device having wireless communications capabilities.

30. A computer readable medium including at least tangible program code executable by a machine, said computer readable medium comprising:
program code for storing ringtone authorization data for each of a plurality of digital media assets;
program code for receiving a ringtone availability request including media asset identification information;
program code for retrieving the ringtone authorization data for a particular digital media asset identified by the media asset information; and
program code for responding to the ringtone availability request based on the retrieved ringtone authorization data.
